(19) United States
(12) Patent Application Publication
(10) Pub. No.: US 2025/0272569 A1
(43) Pub. Date: Aug. 28, 2025

(54) GENERATION OF USER-SPECIFIC ELECTRONIC PROMPTS FOR A COMPUTING-BASED PROCESS

(71) Applicant: INTERNATIONAL BUSINESS MACHINES CORPORATION, Armonk, NY (US)

(72) Inventors: Jennifer M. HATFIELD, Portland, OR (US); Kara A. SMOOT, Baltimore, MD (US); Charles DIGGS, JR., Palo Alto, NM (US); Vinod A. VALECHA, Pune (IN); Juhi BHARAT, Highland Park, NJ (US)

(21) Appl. No.: 18/588,345

(22) Filed: Feb. 27, 2024

(51) Int. Cl. G06N 3/092; G06F 18/2413

(52) U.S. Cl. CPC G06N 3/092; G06F 18/24147

(57) ABSTRACT

An intelligent workflow process is provided to facilitate generating electronic prompt(s) for a user of a computing system to provide customized assistance to the user in carrying out a computing-based process. Generating the prompt(s) includes identifying, by an artificial intelligence agent with reference to user data, the computing-based process initiated by the user, where the user data includes historical data relevant to the computing-based process. In addition, the generating includes determining, by the artificial intelligence agent using a machine learning model and the user data, one or more typical actions of the user relevant to the computing-based process, and producing, based on the one or more typical actions of the user relevant to the computing-based process, the electronic prompt(s) for the user. In addition, the electronic prompt(s) are provided, to the user's computing system to facilitate the customized assistance to the user in carrying out the computing-based process.

### BACKGROUND

One or more aspects relate, in general, to facilitating processing within a computing environment, and more particularly, to providing data-analysis-based assistance to a user in carrying out a computing-based process.

A computing-based process or workflow includes a series of interactive computing activities that are necessary to complete the process or task. Oftentimes, the burden is upon the user to look for and find information, or to understand a next step in the process, in order to carry out the computing-based process.

### SUMMARY

Certain shortcomings of the prior art are overcome, and additional advantages are provided herein through the provision of a computer-implemented method of facilitating processing within a computing environment. The computer-implemented method includes generating, by an artificial intelligence agent, one or more electronic prompts for a user of a computing system to facilitate customized assistance to the user in carrying out a computing-based process. The generating includes identifying, by the artificial intelligence agent with reference to user data, the computing-based process, where the user data includes historical user data relevant to the computing-based process, and determining, by the artificial intelligence agent using a machine learning model and the user data, one or more typical actions of the user relevant to the computing-based process. Further, generating the one or more electronic prompts includes producing, by the artificial intelligence agent based on the one or more typical actions of the user relevant to the computing-based process, the one or more electronic prompts for the user. In addition, the computer-implemented method includes providing, by the artificial intelligence agent, the one or more electronic prompts to the user's computing system to provide customized assistance to the user in carrying out the computing-based process.

Computer program products and computing systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIGS. 2A-2B depict one embodiment of a computer program product with an intelligent workflow module, in accordance with one or more aspects of the present disclosure;

FIG. 3 depicts one embodiment of an intelligent workflow process, in accordance with one or more aspects of the present disclosure;

FIG. 4 is a further example of a computing environment to include and/or use one or more aspects of the present disclosure;

FIG. 5 is another example of a computing environment to include and/or use one or more aspects of the present disclosure;

FIG. 6 depicts one example of artificial intelligence modeling, in accordance with one or more aspects of the present disclosure;

FIG. 7 depicts another embodiment of an intelligent workflow process, in accordance with one or more aspects of the present disclosure; and

FIGS. 8A-8B depict a further embodiment of an intelligent workflow process, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known systems, devices, processing techniques, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative control embodiment can be implemented in software, hardware, or a combination thereof.

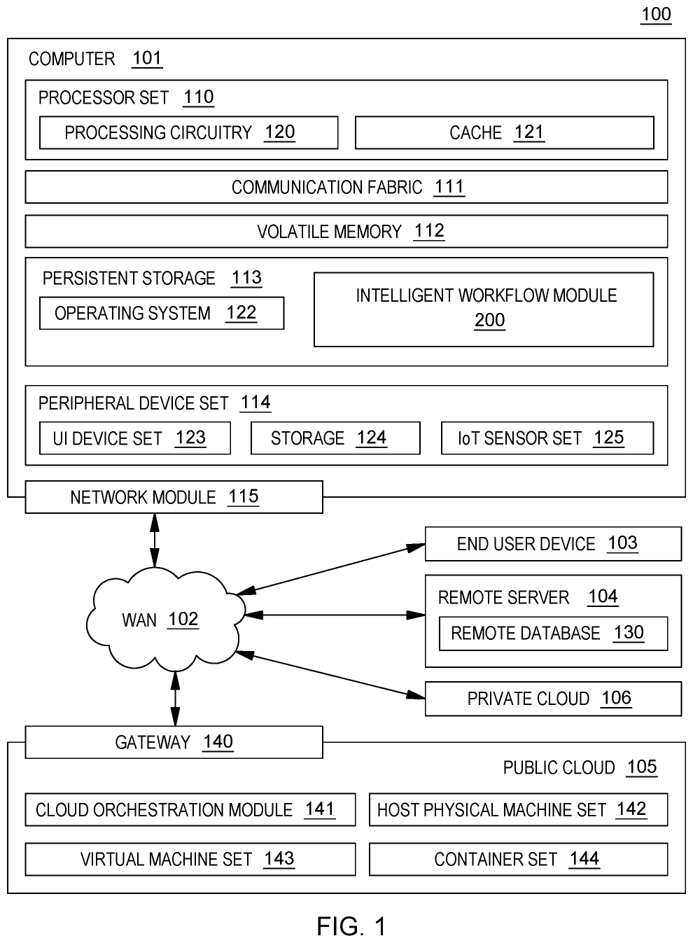

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and intelligent workflow module 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform intelligent workflow processing, such as disclosed herein. Aspects of the present disclosure are not limited to a particular architecture or environment.

Prior to further describing detailed embodiments of the present disclosure, an example of a computing environment to include and/or use one or more aspects of the present disclosure is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as intelligent workflow module 200. In addition to intelligent workflow module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and intelligent workflow module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

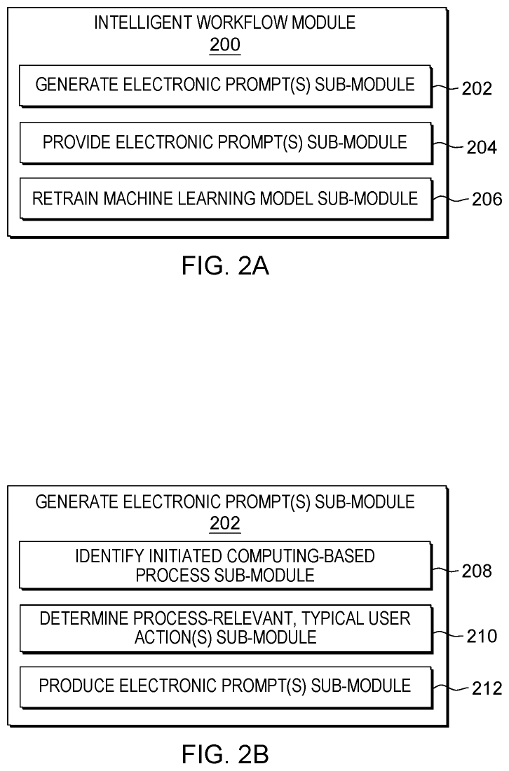

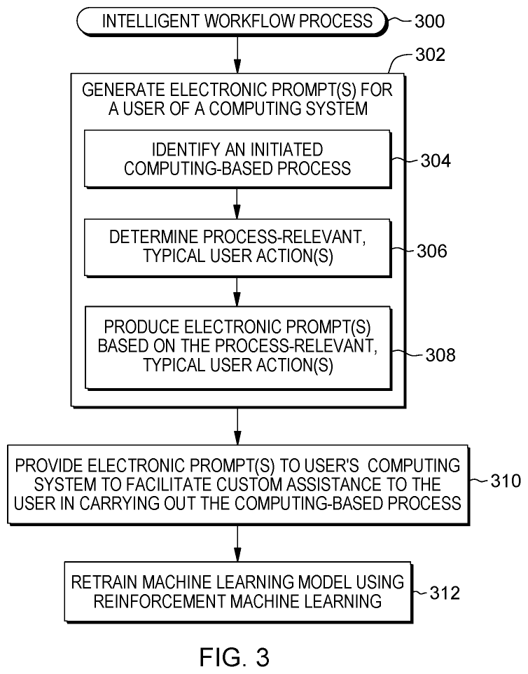

By way of example, one or more embodiments of an intelligent workflow module and process are described initially with reference to FIGS. 2A-3. FIGS. 2A-2B depict one embodiment of intelligent workflow module 200 that includes code or instructions to perform intelligent workflow-related processing, in accordance with one or more aspects of the present disclosure, and FIG. 3 depicts one embodiment of an intelligent workflow process, in accordance with one or more aspects of the present disclosure.

Referring to FIGS. 1-2B, intelligent workflow module 200 includes, in one example, various sub-modules used to perform processing, in accordance with one or more aspects of the present disclosure. The sub-modules are, e.g., computer-readable program code (e.g., instructions) and computer-readable media (e.g., persistent storge (e.g., persistent storage 113, such as a disk) and/or a cache (e.g., cache 121), as examples). The computer-readable media can be part of a computer program product and can be executed by and/or using one or more computers, such as computer(s) 101; one or more processor sets 110 (FIG. 1); processors, such as one or more processors of processor set 110; and/or processing circuitry, such as processing circuitry of processor set 110, etc.

As noted, FIGS. 2A-2B depict one embodiment of an intelligent workflow module 200 which, in one or more embodiments, includes, or facilitates, intelligent workflow processing in accordance with one or more aspects of the present disclosure. In the embodiment of FIGS. 2A-2B, example sub-modules of intelligent workflow module 200 include a generate electronic prompt(s) sub-module 202 to facilitate generating, by an artificial intelligence agent, one or more electronic prompts for a user of a computing system to facilitate customized assistance to the user during an interactive computing-based process. In addition, intelligent workflow module 200 also includes a provide electronic prompt(s) sub-module 204 to provide, by the artificial intelligence agent, the one or more electronic prompts to the user's computing system to provide the customized assistance to the user in carrying out the computing-based process, and a retrain machine learning model sub-module 206 to facilitate retraining of a machine learning model used in generating the one or more electronic prompts, with the retaining being based, for instance, on further user data derived from one or more further user actions relevant to the computing-based process.

As illustrated in FIG. 2B, the generate electronic prompt(s) sub-module 202 includes, in one or more embodiments, an identify initiated computing-based process sub-module 208 to facilitate identifying, by the artificial intelligence agent with reference to user data, the computing-based process initiated by a user via the computing system, where the user data includes historical user data relevant to the computing-based process. In addition, in one or more embodiments, generate electronic prompt(s) sub-module 202 includes a determine process-relevant, typical user action(s) sub-module 210 to facilitate determining, by the artificial intelligence agent using a machine learning model and the user data, one or more typical actions of the user relevant to the computing-based process. Further, generate electronic prompt(s) sub-module 202 includes, in one or more embodiments, a produce electronic prompt(s) sub-module 212 to produce, by the artificial intelligence agent based on the one or more typical actions of the user relevant to the computing-based process, the one or more electronic prompts for the user.

Note that although various sub-modules are described herein, intelligent workflow module processing, such as disclosed, can use, or include, additional, fewer, and/or different sub-modules. A particular sub-module can include additional code, including code of other sub-modules, or less code. Further, additional and/or fewer sub-modules can be used. Many variations are possible.

Advantageously, in one or more aspects, improved processing within a computing environment is provided herein by, for instance, providing customized electronic assistance to a user in carrying out a computing-based process. The customized assistance includes, in one or more embodiments, one or more electronic prompts being provided to the user. In one or more embodiments, the intelligent workflow module and process provide electronic prompts customized to the individual user of the computing-based process to make the interactive computing-based process more efficient, such as, for instance, by eliminating a burden on the user to look for and find certain information and/or to understand a next step in the computing-based process. In one or more implementations, the artificial intelligence agent surfaces one or more proper calls to action for the user during the computing-based process, and presents the calls to action with a best path forward as part of the one or more electronic prompts, where the best path forward is based, for instance, on one or more typical actions of the user relevant to the computing-based process.

In one or more embodiments, the intelligent workflow module is used, in accordance with one or more aspects of the present disclosure, to perform intelligent workflow-related processing. FIG. 3 depicts one example of an intelligent workflow process 300, such as disclosed herein. The process is executed, in one or more embodiments, by a computer (e.g., computer 101 (FIG. 1)), and/or one or more processor sets, such as a processor or processing circuitry (e.g., of processor set 110 of FIG. 1). In one example, code or instructions implementing the process, are part of a module, such as intelligent workflow module 200. In other examples, the code can be included in one or more other modules and/or one or more other sub-modules of the one or more other modules. Various options are available.

As illustrated in FIG. 3, in one example, intelligent workflow process 300 executing on one or more computers (e.g., computer 101 of FIG. 1), one or more processor sets (e.g., processor set 110 of FIG. 1, such as a processor of processing circuitry of the processor set) generates one or more electronic prompts for a user of a computing system 302. In one or more embodiments, generating the one or more electronic prompts includes identifying, by an artificial intelligence agent with reference to user data, the computing-based process initiated by a user via the computing system, where the user data includes historical user data relevant to the computing-based process 304. In addition, generating the one or more electronic prompts for the user, includes determining process-relevant, typical user actions 306. In one embodiment, the determining includes determining, by the artificial intelligence agent using a machine learning model and the user data, one or more typical actions of the user relevant to the computing-based process. Further, generating the one or more electronic prompts, includes producing, by the artificial intelligence agent, the electronic prompts based on the process-relevant, typical user action(s) 308.

In one or more embodiments, the intelligent workflow process 300 further includes providing, by the artificial intelligence agent, the one or more electronic prompts to the user's computing system to provide the customized assistance to the user in carrying out the computing-based process 310. In one embodiment, the one or more electronic prompts can be displayed as one or more user-interface overlays on a display of the computing system used by the user.

In one or more implementations, the intelligent workflow process 300 of FIG. 3 further includes retraining one or more machine learning models used, by the artificial intelligence agent, in generating the one or more electronic prompts, such as the machine learning model used to determine the one or more typical actions of the user relevant to the computing-based process 312. In one embodiment, the retraining of the machine learning model(s) can be via reinforcement machine learning based, for instance, on further user data derived from one or more further user actions in carrying out the computing-based process. The retraining of the machine learning model is, in one embodiment, to facilitate enhancing effectiveness to the user of generated electronic prompts over time.

In one or more embodiments, a capability is provided to facilitate processing within a computing environment and/or to impact user completion of a computing-based process within the computing environment. In one or more aspects, the computing environment is improved by the selective retrieval and processing of data (e.g., based on vast amounts of data from a plurality of sources, including exogeneous sources) to assist a user in performing a specific computing-based process or task (e.g., to facilitate user engagement with an intelligent workflow). In one or more embodiments, user-preference-based electronic prompts are generated to provide customized assistance to the user in carrying out the computing-based process.

In one or more aspects, the computing systems disclosed use artificial intelligence (e.g., execute at least one artificial intelligence agent) to provide data-analysis-based, customized user assistance in carrying out the computing-based process. In one or more embodiments, artificial intelligence includes machine learning, which can further include deep learning comprised of neural networks. In one aspect, artificial intelligence, such as, but not limited to, generative artificial intelligence, generative pretrained transformer and large language model capabilities, can use deep learning models that take raw data and learn to generate statistically probable outputs. Artificial intelligence enables a computing system or device (e.g., at least one artificial intelligence agent executing on the computing system) to obtain and/or derive information, learn from that information, and generate specific outputs, such as electronic prompts, to facilitate a user in performing the particular computing-based process, thereby improving processing, including processing within the computing system. Processing capabilities are improved by using, for instance, communication networks to access a plurality of (e.g., many) data sources, including exogenous data sources, to obtain data that is analyzed and used to take action (e.g., generate one or more electronic prompts) to facilitate the user carrying out the computing-based process, that may otherwise take longer to complete. Thus, processing speed is improved by eliminating, based on data analysis, unnecessary user-related processing activities, actions, inactions, etc., by providing customized assistance to the user in carrying out the computing-based process.

In one or more aspects, artificial intelligence is included in an intelligent workflow. An intelligent workflow is the orchestration of automation, artificial intelligence, analytics, and skills, to fundamentally change how work is performed. An intelligent workflow uses, for instance, artificial intelligence, to obtain data, including real-time data, and/or vast amounts of data, analyze the data, and perform action(s). In one or more aspects, an intelligent workflow can be generated for a particular entity (e.g., a user or a group of users) and during execution, the workflow can repeatedly (e.g., at selected times, periodically, at fixed intervals, at certain times based on signals indicating one or more changes, based on events germane to the execution transpiring, based on schedule, continuously, etc.) evaluate the user's action and the computing-based process to, for instance, optimize the user's experience in performing the computing-based process.

Note that in some embodiments, the intelligent workflow processing disclosed herein can further include registering users with the artificial intelligence system or agent to facilitate the processing. In one or more embodiments, the intelligent workflow process can begin with, or be in response to, receiving permission from a user for data collection relevant to one or more computing-based processes, and registering the user with the system. To the extent implementations of the present disclosure collect, store, or employ personal information provided by, or obtained from, a user (such as previous computing-based process actions, historical action data, and other user data from one or more data sources, such as various platforms, applications, online actions, etc., relevant to the user carrying out a current or specified computing-based process, etc.), such information shall be used in accordance with all applicable laws concerning protection of personal information. Additionally, the collection, storage, and use of such information may be subject to consent of the individual to such activity, for example, through “opt-in” or “opt-out” processes, as may be appropriate for the situation and type of information. Storage and use of personal information is in an appropriately secure manner reflective of the type of information, for example, through various encryption techniques for particularly sensitive information.

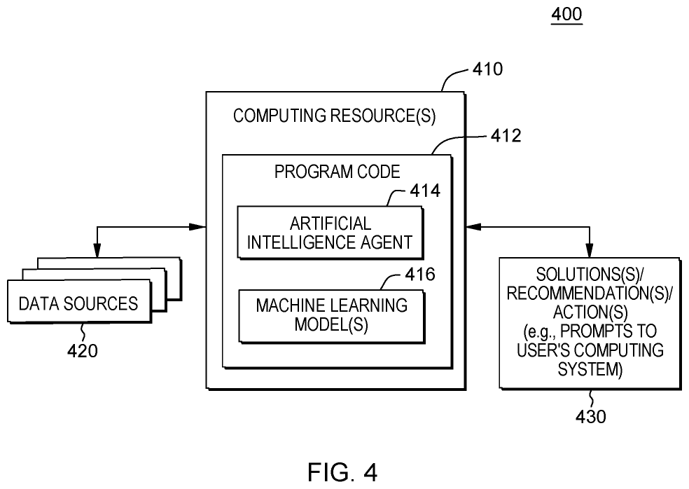

By way of further explanation, FIG. 4 depicts another embodiment of a computing environment or system 400, which can incorporate, or implement, one or more aspects of an embodiment of the present disclosure. In one or more implementations, system 400 is implemented as part of, or includes, a computing environment, such as computing environment 100 described above in connection with FIG. 1. System 400 includes one or more computing resources 410, such as one or more computers 101 of FIG. 1, that execute program code 412 that implements, for instance, one or more aspects of a module or facility such as disclosed herein, and which includes an artificial intelligence agent or system 414, which utilizes one or more machine learning models 416, such as described herein. In one embodiment, data, such as user-action-related data, knowledge corpus database data, or other data associated with generating one or more electronic prompts to facilitate customized assistance to a user in carrying out a computing-based process, in accordance with one or more aspects disclosed herein, can be used by artificial intelligence agent 414, to train model(s) 416 to (for instance), generate one or more electronic prompts for a user of a computing system to facilitate customized assistance to the user in carrying out a computing-based process (such as to determine one or more typical actions of the user relevant to the computing-based process and used by the artificial intelligence agent in generating the one or more electronic prompts), and/or other related actions 430, etc., based on the particular application of the machine-learning model(s) to facilitate achieving the intelligent workflow process disclosed. In implementation, system 400 can include, or utilize, one or more networks for interfacing various aspects of computing resource(s) 410, as well as one or more data sources 420 providing data, and one or more components, systems, etc., receiving an output, action, etc., 430 of machine learning model(s) 416 to facilitate performance of one or more artificial intelligence agent operations. By way of example, the network(s) can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training data for the machine-learning model, and an output solution, recommendation, action, of the machine-learning model(s), such as discussed herein.

In one or more implementations, computing resource(s) 410 house and/or execute program code 412 configured to perform computer-implemented methods in accordance with one or more aspects of the present invention. By way of example, computing resource(s) 410 can be a computing-system-implemented resource(s). Further, for illustrative purposes only, computing resource(s) 410 in FIG. 4 is depicted as being a single computing resource. This is a non-limiting example of an implementation. In one or more other embodiments, computing resource(s) 410, which implements one or more aspects of processing such as discussed herein, can, at least in part, be implemented in multiple separate computing resources or systems, such as one or more computing resources of a cloud-hosting environment, by way of example.

Briefly described, in one embodiment, computing resource(s) 410 can include one or more processor sets with one or more processors, for instance, central processing units (CPUs). Also, the processor set(s) can include functional components used in the integration of program code, such as functional components to fetch program code from locations in such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the artificial intelligence agent and machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s), or computing system(s) or competitor(s), which can implement one or more aspects disclosed are described further herein with reference to the figures.

As noted, in one embodiment, program code 412 includes, or executes, an artificial intelligence agent 414 which utilizes and, optionally trains, one or more machine learning models 416. The models can be trained using training data that can include a variety of types of data, depending on the model and the data sources. In one or more embodiments, program code 412 executing on one or more computing resources 410 applies one or more algorithms of, for instance, artificial intelligence agent 414 to generate and train the model(s), which the program code then utilizes to, for instance, determine one or more typical actions of a user relevant to a particular computing-based process, and in particular, relevant to one or more aspects or components of the computing-based process, where the user is currently engaged within the computing-based process, and/or to generate one or more electronic prompts for the user using, for instance, the one or more typical actions of the user relevant to the computing-based process. In an initialization or learning stage, program code 412 trains the one or more machine learning models 416 using obtained training data that can include, in one or more embodiments, user data, or other data to be used by the artificial intelligence agent workflow to, for instance, determine one or more typical actions of a user relevant to a particular computing-based process, and in particular, relevant to one or more aspects or components of the computing-based process, where the user is currently engaged within the computing-based process, and/or to generate one or more electronic prompts for the user using, for instance, the one or more typical actions of the user relevant to the computing-based process, such as described herein.

Data used to train the models (in one or more embodiments of the present invention) can include a variety of types of data, such as heterogeneous user data (or user-related data) generated by one or more data sources and/or data stored in one or more databases accessible by, the computing resource(s). Program code, in embodiments of the present invention, can perform data analysis to generate data structures, including algorithms utilized by the program code to predict and/or perform an action. As known, machine-learning-based modeling solves problems that cannot be solved by numerical means alone. In one example, program code extracts features/attributes from training data, which can be stored in memory or one or more databases. The extracted features can be utilized to develop a predictor function, h (x), also referred to as a hypothesis, which the program code utilizes as a model. In identifying machine learning model(s) 416, various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weight various attributes (e.g., features, patterns) that correlate to enhanced performance of the model.

In one or more embodiments, program code, executing on one or more processors, utilizes an existing cognitive analysis tool or agent (now known or later developed) to tune the model, based on data obtained from one or more data sources. In one or more embodiments, the program code can interface with application programming interfaces to perform a cognitive analysis of obtained data. Specifically, in one or more embodiments, certain application programing interfaces include a cognitive agent (e.g., learning agent) that includes one or more programs, including, but not limited to, natural language classifiers, a retrieve-and-rank service that can surface the most relevant information from, for instance, monitoring user actions relevant to a computing-based process, such as from a collection of user data, concepts/visual insights, tradeoff analytics, document conversion, and/or relationship extraction. In an embodiment, one or more programs analyze the data obtained by the program code across various sources utilizing one or more of a natural language classifier, retrieve-and-rank application programming interfaces, and tradeoff analytics application programing interfaces, etc.

In one or more embodiments, the program code can utilize one or more neural networks to analyze training data and/or collected data to generate an operational machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present invention, can utilize in implementing a machine-learning model, such as described herein.

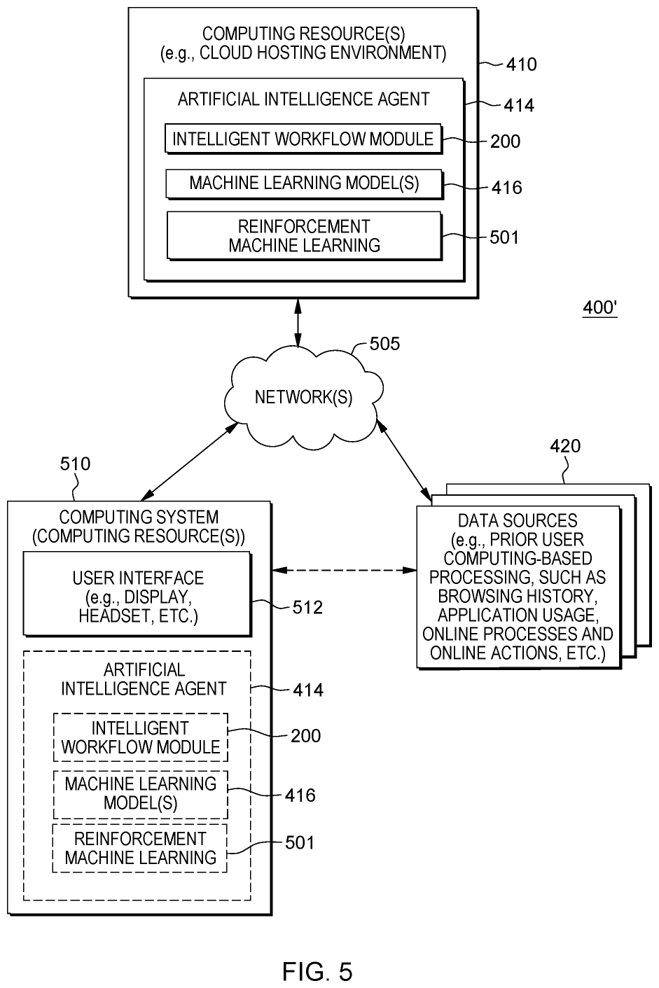

FIG. 5 depicts another embodiment of a computing environment or system into which various aspects of some embodiments of the present invention can be implemented. By way of example, computing environment 400′ can incorporate, or implement, one or more aspects of an embodiment of the present invention. In one or more implementations, computing environment 400′ can be the same as or similar to system 400 of FIG. 4, and can include, or be implemented as part of, a computing environment, such as computing environment 100 described above in connection with FIG. 1. Computing environment 400′ includes one or more computing resources 410, such as one or more cloud-hosting computing resources, that execute program code that implement, for instance, an artificial intelligence agent 414 incorporating or using an artificial intelligent workflow module 200, such as disclosed herein. In one or more embodiments, intelligent workflow module 200 utilizes one or more machine learning models 416, as well as reinforcement machine learning 501, to facilitate generating, by the artificial intelligence agent 414, one or more electronic prompts for a user of a computing system to facilitate customized assistance to the user in interactively carrying out a computing-based process.

As noted, in one or more embodiments, the intelligent workflow process includes obtaining user data relevant, at least in part, to the user carrying out the computing-based process. In one embodiment, computing environment 400′ also includes one or more data sources 420, as well as one or more computing systems 510 operatively coupled to and in communication with computing resource(s) 410 via one or more networks 505. Network(s) 505 can be, for instance, a telecommunications network, a local area network (LAN), a wide-area network (WAN), such as the Internet, or a combination thereof, and can include wired, wireless, fiber-optic connections, etc. The network(s) 505 can include one or more wired and/or wireless networks that are capable of receiving and transmitting data, including user data, such as browsing history data, application usage data, online data, process-related user action data, etc., as helpful to facilitate the artificial intelligence processing disclosed.

In one or more embodiments, computing system 510, such as a user computing system (or a computing system being used by the user), can include a user interface 512 (such as a display, headset, etc.) to facilitate the user interactively carrying out one or more computing-based processes, and to facilitate receiving and, for instance, displaying, the one or more electronic prompts disclosed herein providing the customized assistance to the user in carrying out a computing-based process.

For illustrative purposes only, artificial intelligence agent 414 with intelligent workflow module 200 is depicted as executing on computing resource(s) 410 separate from the user's computing system 510. This a non-limiting example of an implementation. In one or more other embodiments, artificial intelligence agent 414, with intelligent workflow module 200, machine learning model(s) 416, and reinforcement machine learning 501, can be (or at least in part be) implemented in association with computing system 510, as another example.

As noted, in one or more aspects, one or more of the activities of the intelligent workflow use an artificial intelligence agent, an intelligent workflow process, one or more machine learning models, and reinforcement machine learning to perform one or more aspects disclosed herein. As an example, at least one artificial intelligence agent is trained and learns based on input. The at least one artificial intelligence agent is trained and retrained to continually learn. In an example, the at least one artificial intelligence agent includes one or more artificial intelligence models that rely on training data to recognize patterns and make predictions or decisions.

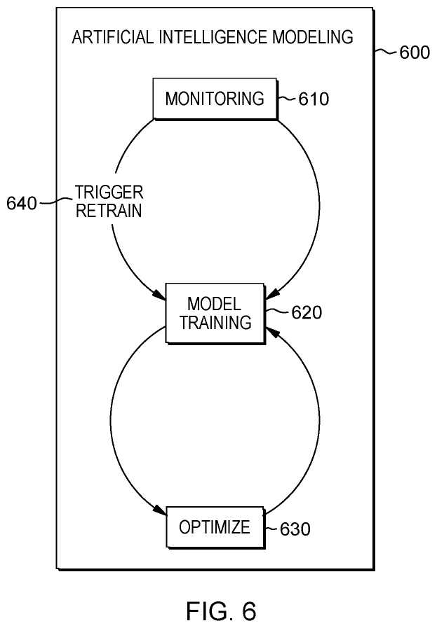

One example of a lifecycle of an artificial intelligence model (or machine learning model) is described with reference to FIG. 6. In one example, a modeling lifecycle 600 includes, for instance, building and training 620 an artificial intelligence model or machine learning model (of, e.g., at least one artificial intelligence agent). The training is based on, for instance, monitoring 610, data analysis and feedback. Based on repeated monitoring and/or analysis, a retraining 640 of the model may be triggered, providing a fluid, rather than static, model used by the intelligent workflow. Based on the model, optimization 630 can be performed. For instance, effectiveness of one or more prompts, processes and/or the intelligent workflow may be optimized (e.g., add, modify, delete). Training 620 may further be performed based on the optimization. Further options are possible. In one or more embodiments, the model is used to generate and execute an intelligent workflow that is dynamic and polymorphic.

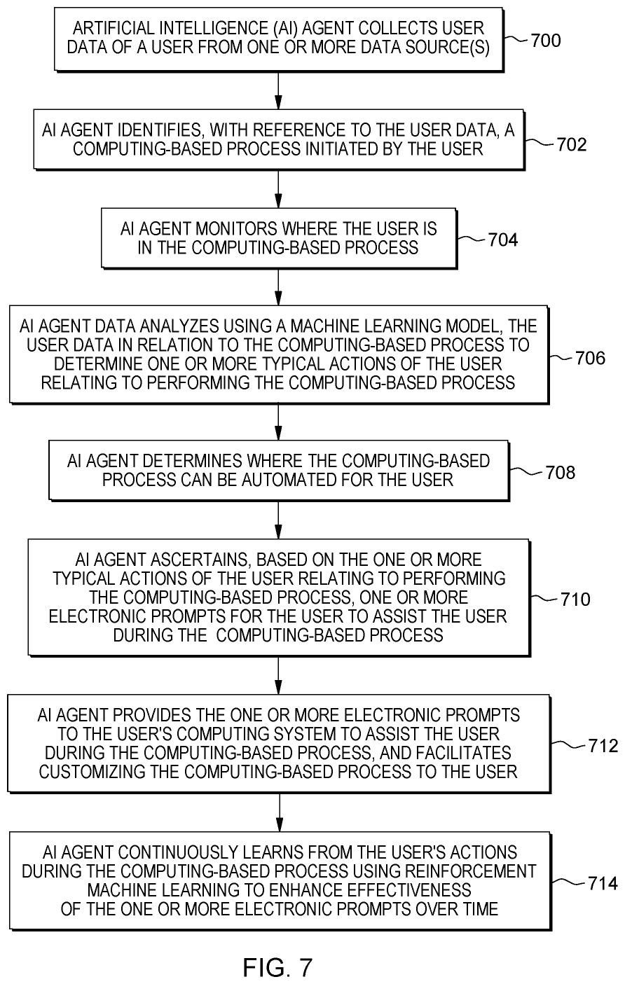

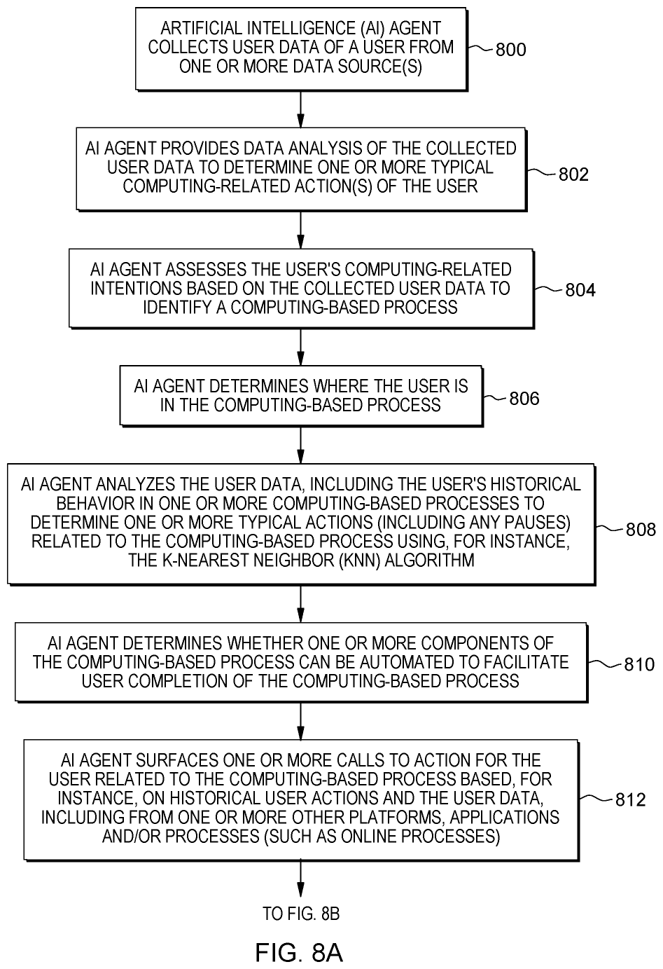

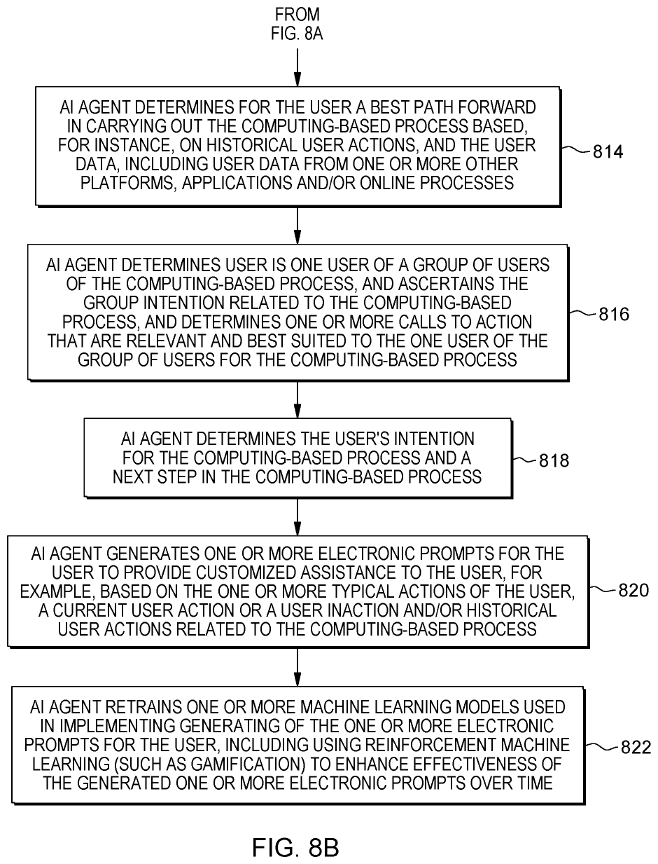

FIGS. 7 and 8A-8B depict further embodiments of intelligent workflow processing, in accordance with one or more aspects of the present disclosure. As described herein, these embodiments disclose processes which improve processing within a computing environment by, for instance, providing customized electronic assistance to a user in carrying out an interactive computing-based process. The customized assistance includes, in one or more embodiments, generating and providing one or more custom electronic prompts to the user. In one or more implementations, the intelligent workflow module and process provide electronic prompts customized to the individual user of a computing-based process to make completion of the computing-based process more efficient, such as, for instance, by eliminating a burden on the user to look for and find certain information and/or understand a next step in the computing-based process. In one or more embodiments, an artificial intelligence agent surfaces one or more calls to action for the user during the computing-based process, and presents the calls to action with, for instance, a best path forward as part of the one or more electronic prompts, where the best path forward is based, for instance, on one or more typical actions of the user relevant to the computing-based process. In one or more implementations, the user initially opts in to the intelligent workflow process by, for instance, registering with the artificial intelligence system to give the system permission to collect user data relevant to one or more computing-based processes for which intelligent workflow processing and assistance is desired.

As described herein, the intelligent workflow process presented is dynamic and adaptable through continual monitoring and learning based on user input and actions relevant to one or more computing-based processes, such as including, for instance, obtaining data to facilitate understanding while the user is within a particular computing-based process, where the user is within the process and a data-analysis-based intention of the user of the process. A variety of types of user data can be obtained, including types of user actions done in the past in connection with the specific computing-based process, one or more regions of the process where the user typically pauses, etc. Additionally, the intelligent system assesses during the computing-based process whether one or more aspects or components of the computing-based process can be automated, and completed for the user. In generating one or ore electronic prompts to provide customized assistance to the user in carrying out a computing-based process, the intelligent system or agent can, for instance, consider multiple aspects of the computing-based process, including, for instance, whether the user is one user of a group of users of the computing-based process (and if so, can surface calls to action that are relevant and best suited to that particular user in the group), can address the group of users at a group level, can evaluate individual user intentions within the computing-based process, and evaluate next steps in the computing-based process, can provide electronic prompts unique to the particular user of the computing-based process, as well as expedite processing and work, such as in shared workspaces. The use of electronic prompts can be triggered by user action, inaction, historical behavior, the user's data-analysis-based intention, the group's data-analysis-based intention, gamification (to facilitate retraining of the one or more machine learning models) such that over time based on positive actions the system provides a user with fewer electronic prompts while still facilitating the user's computing-based process.

In one or more embodiments, the intelligent workflow system or agent disclosed herein understands primary elements of the computing-based process and required user interactions with the process that lead to successful completion of one or more tasks within the process. Further, the system monitors user interactions, lack of usage, notes trouble areas and task completion cadence over time to generate and provide, for instance, custom electronic prompts to the user to facilitate carrying out the computing-based process. The intelligent system can test user preferred interactions through design prompts and frequency of use. The system can further design electronic prompts based on preferred stimuli with adaptability over time based on, for instance, the user's learning speed. Further, in one or more embodiments, the system is configured to understand what aspects of a computing-based process can be automated based on understanding the user instructing or teaching the system through repeated actions associated with the computing-based process. Advantageously, the artificial intelligent agent or system disclosed herein can be implemented in any digital environment, with any operating system. Intelligent workflow processes are presented which, in one or more embodiments, personalize the user interface and/or elements of the computing-based process using, for instance, one or more electronic prompts to the user's computing system provided during the process. In one or more embodiments, the electronic prompts enhance and bring additional impact to an intelligent workflow process by, for instance, further enhancing a user's interaction with the intelligent workflow. Note that as used herein, the computing-relating process being carried out by the user can be any of a variety of computing-based processes including, for instance, work related computing-based processes, as well as non-work related computing-based processes of a particular user. Note also that a variety of types of electronic prompts can be generated and provided to the user to facilitate, for instance, successful completion of the computing-based process. The electronic prompts can be any of a wide variety of types of prompts depending on the process, as well as the type of computing system being employed by the user. For instance, in one or more embodiments, the prompts can relate to configuring a user interface of the computing system to facilitate user completion and satisfaction with completion of the computing-based process, or to automatically configuring presentation of online website material, or facilitate completion of a particular task of the computing-based process, facilitate extraction and presenting information related to a particular data analysis-based intention of the user in performing the computing-based process, etc.

Referring to FIG. 7, an intelligent workflow process is illustrated which assumes, in one or more embodiments, that the user has already registered with the intelligent workflow system to give permission to the system to collect user data. As such, in one or more embodiments, the artificial intelligence (AI) agent collects user data of a user from one or more data sources 700, such as described herein. The AI agent identifies, with reference to the user data, a computing-based process initiated by the user 702, and monitors where the user is within the computing-based process 704. In the embodiment of FIG. 7, the AI agent further data analyzes, using a machine learning model, the user data in relation to the computing-based process to determine one or more typical actions of the user relating to performing the computing-based process 706. The one or more typical actions can be one or more prior actions to the user in performing the same computing-based process or similar computing-based processes, in one or more emboidments.

In the embodiment of FIG. 7, the AI agent determines where the computing-based process can be automated for the user 708, and in one embodiment, can include initiating an inquiry or prompt about automation of one or more aspects of the process for the user. The AI agent ascertains, based on the one or more typical actions of the user relating to performing the computing-based process, one or more electronic prompts for the user to assist the user during the computing-based process 710. Further, in the embodiment illustrated, the AI agent provides the one or more electronic prompts to the computing system being used by the user to assist the user during the computing-based process and thereby facilitate customizing the computing-based process to the user 712. In one or more embodiments, the AI agent continuously learns from the user's actions during the computing-based process, as well as other computing-based processes of the user as well as other users, using reinforcement machine learning to enhance effectiveness of the one or more electronic prompts being provided to the user over time 714.

FIGS. 8A-8B depict a further embodiment of an intelligent workflow process, in accordance with one or more aspects of the present disclosure. In one or more implementations, intelligent workflow process of FIGS. 8A-8B assumes that the user has opted into the intelligent system and process by registering with the system to allow for monitoring and collection of user data relevant to one or more particular computing-based processes, such as one or more intelligent workflow computing-based processes. In one or more embodiments, the registering with the intelligent system can be specific to facilitating performance of a particular computing-based process or a group of computing-based processes or to assist with performance of any type of computing-based process.

Referring to the process of FIGS. 8A-8B, in one or more embodiments, the artificial intelligent (AI) agent collects user data for a user from one or more data sources 800. For instance, the intelligent system can collect user data from various sources, such as on the user's browsing history, application usage, online actions, etc. The AI agent performs data analysis of collected user data to determine one or more typical computing-related actions of the user 802, such as typical data-analysis-based preferences, behaviors and/or intentions of a user related to one or more computing-based processes. In one or more embodiments, the AI agent assesses the user's computing-related intentions based on the collected user data to identify a particular computing-based process with which the user is engaged 804. In one or more embodiments, the AI agent determines where the user is in the computing-based process 806. For instance, the intelligent system can determine where the user is in a specific computing-based process, such as a specific multistep computing process (e.g., multistep form, multistep product configuration process, etc.).

In one or more embodiments, the AI agent analyzes the user data including the user's historical behavior in one or more computing-based processes to determine one or more typical actions (including any pauses) related to the current computing-based process using, for instance, one or more machine learning algorithms 808. For instance, in one embodiment, the machine learning algorithm can be, or include a K-Nearest Neighbor (KNN) algorithm to assist in determining the one or more typical actions of the user related to the computing-based process. The K-Nearest Neighbor (KNN) algorithm is an effective machine learning algorithm used for classification and regression. It works by identifying the K-nearest data points to a given data input point, and then predicts the output value based on the most common output value among the K neighbors. In the context of analyzing historical user behavior to understand typical user actions related to a computing-based process, and points where the user typically pauses in a specific process, the KNN algorithm can be used to identify patterns of behavior based on past user actions in connection with the computing-based process or other computing-based processes. By using KNN to identify patterns of user behavior based on past actions (including, for instance, past user actions and other user actions associated with or related to the computing-based process), the intelligent system can provide the user with personalized prompts and guidance to help the user complete the computing-based process more efficiently and accurately. For instance, the intelligent system can provide prompts (that is, electronic prompts, nudges or reminders) to the user to complete a particular aspect or section of the computing-based process if the user is predicted to skip that section, or provide additional guidance to the user or support if the user is predicted to take longer to complete a specific aspect or section of the computing-based process.

As part of the AI agent analyzing the user data, the intelligent agent or system can determine the user's data-analysis-based intentions, location in the computing-based process, and historical behavior associated with the computing-based process or similar computing-based processes, and based thereon, identify one or more relevant calls to action to the user to be presented as one or more electronic prompts to the user's computing system for, for instance, display on a user interface as user interface overlays (in one example). In one or more embodiments, the AI agent determines whether one or more components or aspects of the computing-based process can be automated to facilitate user completion of the computing-based process 810. In one embodiment, the AI agent surfaces one or more calls to action for the user related to the computing-based process based, for instance, on historical user actions and the user data, including data from one or more other electronic platforms, applications, processes (such as online processes), etc. 812. Note that in one or more embodiments, the one or more electronic prompts described herein can be, or include, electronic prompts, electronic nudges and/or automation options being provided to the user's computing system, for instance, for display to the user during the computing-based process to facilitate the user carrying out the computing-based process.

As illustrated in FIG. 8B, in one or more embodiments, the AI agent determines for the user a best path forward in carrying out the computing-based process based, for instance, on related historical user actions and the user data, such as user data from one or more prior instances of completing the computing-based process, and/or user data from one or more other electronic platforms, applications and/or processes 814. In one embodiment, the AI agent also determines whether the user is one user of a group of users of the computing-based process, and, if so, ascertains by data analysis group intention relating to the computing-based process, and determines one or more calls to action that are relevant and best suited to the one user of the group of users for the computing-based process 816. In this embodiment, the intelligent system can consider a group intention and group behaviors with respect to the computing-based process to allow the system to surface calls to action that are relevant and best suited to the particular user in the group. In one or more embodiments, the AI agent determines the user's intention via data analysis of the user data for the computing-based process, and in one embodiment, determines a next step in the computing-based process 818 to provide user specific electronic prompts including prompts triggered, for instance, by prior or current user action, user inaction, historical user data, or data analysis based intention of the user, and in one or more implementations, can provide electronic prompts with a goal of modifying the user's behavior in connection with carrying out the computing-based process as directed, for instance, by the user's employer in a workplace embodiment. In one or more embodiments, the AI agent generates one or more electronic prompts for the user to provide customized assistance to the user, for example, based on the one or more typical actions of the user, a current user action, a user inaction and/or historical user data or historical user actions related to the computing-based process 820. In this manner, the intelligent system provides a personalized experience to the user based on their prior actions, such as their prior preferences and behaviors associated with carrying out the computing-based process, or similar computing-based processes, thereby reducing the burden of carrying out and navigating a complex computing-based process on the user.

In one or more embodiments, the AI agent retrains one or more machine learning models used in implementing the generating of the one or more electronic prompts for the user, including using reinforcement machine learning (such as gamification) to enhance the effectiveness of the generated one or more electronic prompts over time 822. For instance, one embodiment of gamification can be used to incentivize positive intelligent system results, such as to provide fewer electronic prompts to a user over time as the user successfully completes the computing-based process. In one embodiment, the intelligent system continuously learns from the user's actions and behaviors, improving relevance and effectiveness of its calls to action (i.e., electronic prompts) over time. Reinforcement machine learning is used for this purpose. Reinforcement learning is a type of machine learning where an artificial intelligent agent learns to make decisions in an environment by performing actions and receiving feedback in the form of rewards or penalties. The goal of the artificial intelligent agent is to maximize the accumulative reward over time. In the present invention, the intelligent system can include, or be viewed as, the artificial intelligent agent, and the user's actions and behavior can be viewed as the environment. The intelligent system takes action such as presenting certain calls to actions, and receives feedback in the form of the user's responses in association with the computing-based process. If the user takes a desired action within the process, such as completing a task or following a certain recommended path, the system is rewarded, and if the user takes an undesired action, such as abandoning a task or ignoring a call to action, the system is penalized. Over time, the intelligent system thus uses reinforcement learning to learn which electronic prompts lead to the best outcomes (i.e., highest reward) and adjusts its recommendations accordingly. This leads to a more effective and relevant calls to action for the user, as the intelligent system learns from the user's responses. In one or more embodiments, an adaptable design based pattern is presented herein as an intelligent system that combines user data, intelligent analysis, and automation to provide users with a personalized and adaptive experience, while reducing the burden on the users of navigating complex computing-based processes.

Those skilled in the art will note that computer-implemented methods, computer program products and computer systems are provided herein for facilitating processing within a computing environment by, for instance, providing data analysis-based intelligent assistance to a user in carrying out a computing-based process. The methods, computer program products and systems provide users with personalized and adaptive experiences in navigating the computing-based process. In one or more embodiments, the computer-implemented methods, computer program products and computer systems include processes such as disclosed herein. For instance, in one embodiment, the artificial intelligence agent identifies, based on collected and analyzed historical user data of, for instance, browsing history, application usage, online actions, etc., a specific computing-based process the user is carrying out, and determines what the next step in the computing-based process is for the user by analyzing the historical user data in relation to the specific computing-based process. In one or more embodiments, the artificial intelligence agent is able to understand typical user actions related to the computing-based process, for instance, using one or more machine learning models or algorithms. In one embodiment, the artificial intelligence agent determines whether a specific process or task can be automated, and completed for the user, and surfaces one or more calls for action as electronic prompts to be provided to the user's computer system. In one or more embodiments, the calls to action can be based on data analysis of historical user data and analyzed typical actions of the user. The one or more electronic prompts provided to the user's computing system are triggered, for instance, by user action, user inaction, historical user behavior, data analysis-based intention of the user in connection with the computing-based process, etc. with the goal of facilitating the user carrying out the computing-based process or, in one embodiment, with the goal of modifying user behavior in relation to the specific computing-based process. In this manner, a personalized experience is provided to the user based on the user data, thereby reducing the burden on the user in navigating complex processes. In one or more embodiments, the artificial intelligence system continuously learns from the user's actions and behaviors within the computing-based process, and other computing-based processes, using reinforcement learning to improve the relevance and effectiveness of calls to action over time. For instance, in one embodiment, gamification can be used to incentivize positive behavior of the artificial intelligence agent, generating fewer electronic prompts overtime as the user completes computing-based process successfully.

The terminology used herein is for the purpose of describing particular embodiments only and is not intended to be limiting of the disclosure. As used herein, the singular forms “a”, “and” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
generating, by an artificial intelligence agent, one or more electronic prompts for a user of a computing system to facilitate customized assistance to the user in carrying out a computing-based process, the generating comprising:
identifying, by the artificial intelligence agent with reference to user data, the computing-based process initiated by the user via the computing system, the user data including historical user data relevant to the computing-based process;
determining, by the artificial intelligence agent using a machine learning model and the user data, one or more typical actions of the user relevant to the computing-based process;
producing, by the artificial intelligence agent based on the one or more typical actions of the user relevant to the computing-based process, the one or more electronic prompts for the user; and
providing, by the artificial intelligence agent, the one or more electronic prompts to the user's computing system to provide the customized assistance to the user in carrying out the computing-based process.

2. The computer-implemented method of claim 1, further comprising retraining the machine learning model using, at least in part, reinforcement machine learning based on further user data derived from one or more further user actions during the computing-based process, the retraining facilitating effectiveness of generated electronic prompts over time.

3. The computer-implemented method of claim 2, wherein the using, at least in part, the reinforcement machine learning comprises using, by the artificial intelligence agent, gamification to enhance effectiveness of the generated electronic prompts over time.

4. The computer-implemented method of claim 1, wherein the machine learning model comprises a K-nearest neighbor (KNN) algorithm.

5. The computer-implemented method of claim 1, wherein the one or more electronic prompts of the artificial intelligence agent present, at least in part, the user with a user-specific path forwarded in carrying out the computing-based process, based on the one or more typical actions of the user relevant to the computing-based process.

6. The computer-implemented method of claim 1, wherein the user data further comprises user data from other computing-based processes relevant to the computing-based process.

7. The computer-implemented method of claim 1, wherein identifying, by the artificial intelligence agent, the computing-based process comprises collecting, by the artificial intelligence agent, the user data and ascertaining a data-analysis-based intention of the user and using, by the artificial intelligence agent, the data-analysis-based intention in identifying the computing-based process.

8. The computer-implemented method of claim 1, wherein the one or more typical actions of the user relevant to the computing-based process include one or more historical user behavioral actions, including any user pauses, related to the user's carrying out of the computing-based process.

9. The computer-implemented method of claim 1, wherein generating the one or more electronic prompts further comprises identifying, by the artificial intelligence agent, one or more components of the computing-based process can be automated by the artificial intelligence agent based, at least in part, on the one or more typical actions of the user relevant to the computing-based process, and the producing of the one or more electronic prompts further being based, at least in part, on the artificial intelligence agent determining that the one or more components of the computing-based process can be automated.

10. The computer-implemented method of claim 1, wherein providing the one or more electronic prompts further comprises providing, by the artificial intelligence agent, the one or more electronic prompts to a user interface of the computing system for display to the user as one or more user interface overlays during the computing-based process.

11. The computer-implemented method of claim 1, wherein the user is one user of multiple users of the computing-based process, and the one or more electronic prompts are generated by the artificial intelligence agent specifically for the one user of the multiple users of the computing-based process.

12. A computer program product for facilitating processing within a computing environment, the computer program product comprising:
a set of one or more computer readable storage media; and
program instructions, collectively stored in the set of the one or more computer readable storage media, for causing at least one processor set to perform computer operations comprising:
generating, by an artificial intelligence agent, one or more electronic prompts for a user of a computing system to facilitate customized assistance to the user in carrying out a computing-based process, the generating comprising:
identifying, by the artificial intelligence agent with reference to user data, the computing-based process initiated by the user via the computing system, the user data including historical user data relevant to the computing-based process;
determining, by the artificial intelligence agent using a machine learning model and the user data, one or more typical actions of the user relevant to the computing-based process;
producing, by the artificial intelligence agent based on the one or more typical actions of the user relevant to the computing-based process, the one or more electronic prompts for the user; and
providing, by the artificial intelligence agent, the one or more electronic prompts to the user's computing system to provide the customized assistance to the user in carrying out the computing-based process.

13. The computer program product of claim 12, wherein the computer operations further comprise retraining the machine learning model using, at least in part, reinforcement machine learning based on further user data derived from one or more further user actions during the computing-based process, the retraining facilitating effectiveness of generated electronic prompts over time.

14. The computer program product of claim 12, wherein the one or more electronic prompts of the artificial intelligence agent present, at least in part, the user with a user-specific path forwarded in carrying out the computing-based process, based on the one or more typical actions of the user relevant to the computing-based process.

15. The computer program product of claim 12, wherein identifying, by the artificial intelligence agent, the computing-based process comprises collecting, by the artificial intelligence agent, the user data and ascertaining a data-analysis-based intention of the user and using, by the artificial intelligence agent, the data-analysis-based intention in identifying the computing-based process.

16. The computer program product of claim 12, wherein generating the one or more electronic prompts further comprises identifying, by the artificial intelligence agent, one or more components of the computing-based process can be automated by the artificial intelligence agent based, at least in part, on the one or more typical actions of the user relevant to the computing-based process, and the producing of the one or more electronic prompts further being based, at least in part, on the artificial intelligence agent determining that the one or more components of the computing-based process can be automated.

17. A computer system for facilitating processing within a computing environment, the computer system comprising:
at least one processor set;
a set of one or more computer readable storage media; and
program instructions, collectively stored in the set of one or more computer readable storage media, for causing the at least one processor set to perform computer operations comprising:
generating, by an artificial intelligence agent, one or more electronic prompts for a user of a computing system to facilitate customized assistance to the user in carrying out a computing-based process, the generating comprising:
identifying, by the artificial intelligence agent with reference to user data, the computing-based process initiated by the user via the computing system, the user data including historical user data relevant to the computing-based process;
determining, by the artificial intelligence agent using a machine learning model and the user data, one or more typical actions of the user relevant to the computing-based process;
producing, by the artificial intelligence agent based on the one or more typical actions of the user relevant to the computing-based process, the one or more electronic prompts for the user; and
providing, by the artificial intelligence agent, the one or more electronic prompts to the user's computing system to provide the customized assistance to the user in carrying out the computing-based process.

18. The computer system of claim 17, wherein the computer operations further comprise retraining the machine learning model using, at least in part, reinforcement machine learning based on further user data derived from one or more further user actions during the computing-based process, the retraining facilitating effectiveness of generated electronic prompts over time.

19. The computer system of claim 18, wherein the using, at least in part, the reinforcement machine learning comprises using, by the artificial intelligence agent, gamification to enhance effectiveness of the generated electronic prompts over time.

20. The computer system of claim 17, wherein the machine learning model comprises a K-nearest neighbor (KNN) algorithm.
